(19) United States
(12) Patent Application Publication
(10) Pub. No.: US 2025/0103374 A1
(43) Pub. Date: Mar. 27, 2025

(54) VIRTUAL MACHINE MIGRATION RESOURCE MANAGEMENT

(71) Applicant: International Business Machines Corporation, Armonk, NY (US)

(72) Inventors: Grzegorz Piotr Szczepanik, KRAKOW (PL); Lukasz Józef Matyasik, KRAKOW (PL); Piotr Mateusz Wodecki, KRAKOW (PL); Szymon Kowalczyk, KRAKOW (PL); Adam Dyszy, Wodzislaw Slaski (PL)

(73) Assignee: International Business Machines Corporation, Armonk, NY (US)

(21) Appl. No.: 18/474,671

(22) Filed: Sep. 26, 2023

(51) Int. Cl. G06F 9/455; G06F 9/50

(52) U.S. Cl. CPC G06F 9/45558; G06F 9/5077; G06F 2009/4557

(57) ABSTRACT

An embodiment generates a compute resource allocation limit parameter for controlling a total amount of compute resources consumed by a set of virtual machines over a combination of a source host environment and a target host environment. The embodiment adjusts an allocation of compute resources for the set of virtual machines according to the compute resource allocation limit parameter. The embodiment migrates the set of virtual machines from the source host environment to the target host environment.

### BACKGROUND

The present invention relates generally to virtual machines. More particularly, the present invention relates to a method, system, and computer program for virtual machine migration compute resource management.

Virtualization is the process of creating a software-based, or “virtual” version of a computer, known as a “virtual machine”, with a dedicated amounts of CPU, memory, and storage that are utilized from a physical host computer. In essence, a virtual machine (VM) is a kind of a computer program enabled to run other computer programs without being tied to a physical machine. In a VM instance, one or more guest VMs can run on a host computer. Each VM may have its own operating system, and may function entirely separately from other VMs, even though the VMs may be located on the same physical host. Accordingly, multiple VMs can share resources from the same physical host, including CPU cycles, memory, storage, and, and network bandwidth. VMs generally run on servers, but a VM can also be run on desktop systems, as well as on embedded platforms.

Virtual machines may be preferred for serving various different purposes, including but not limited to, running multiple applications together, monolithic applications, isolation between applications, and for legacy applications running on older operating systems. Because the software is separate from the physical host computer, users can run multiple operating system (OS) instances on a single piece of hardware, saving a company time, management costs and physical space. Another advantage is that VMs can support legacy applications, reducing or eliminating the need and cost of migrating an older application to an updated or different operating system. In addition, developers may use VMs in order to test apps in a safe, sandboxed environment. Developers looking to see whether their applications will work on a new OS can utilize VMs to test their software instead of purchasing the new hardware and OS ahead of time. Further, VMs may be utilized for server virtualization in order to enable companies to utilize the compute power of their physical servers more efficiently, reducing the number of physical servers and saving space in the data center. Because apps with different OS requirements could run on a single physical host, different server hardware might not be required for each OS. Accordingly, virtualization is a popular technology at least because virtualization helps companies centralize and better utilize the hardware resources.

VM migration is the process of moving one or more VMs from physical host to another physical host, and/or from one data store to another data store. Accordingly, the migration content may include compute resources, data storage, or both. The two types of VM migration include “cold” migration and “hot” migration. Cold migration is performed when the VM is shut down, while hot migration is performed live while the VM is actually running. Every so often, one more VMs will be migrated from the VM's current physical host to a new physical host. During the process of migration, it may be the case that a portion of VMs remain on the current (old) host, while VMs are being migrated to the new host. To successfully accomplish a VM migration, it is important for an IT administrator to understand the compute resource utilized on the source host, the differences between physical and virtual environment, and/or the differences between the source host and the target host.

### SUMMARY

The illustrative embodiments provide for virtual machine migration resource management. An embodiment includes generating a compute resource allocation limit parameter for controlling a total amount of compute resources consumed by a set of virtual machines over a combination of a source host environment and a target host environment. The embodiment also includes adjusting an allocation of compute resources for the set of virtual machines according to the compute resource allocation limit parameter. The embodiment also includes migrating the set of virtual machines from the source host environment to the target host environment. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of a computing environment in accordance with an illustrative embodiment;

FIG. 3 depicts a block diagram of an example virtual machine host environment in accordance with an illustrative embodiment;

FIG. 4A depicts a block diagram of an example processing environment of a virtual machine resource management module in accordance with an illustrative embodiment;

FIG. 4B depicts a block diagram of an example processing environment of a virtual machine resource management module in accordance with an illustrative embodiment;

FIG. 5 depicts a block diagram of an example virtual machine migration process in accordance with an illustrative embodiment;

FIG. 6A depicts a table illustrating an example hypothetical pre-migration scenario in accordance with an illustrative embodiment;

FIG. 6B depicts a depicts a table illustrating an example hypothetical migration scenario in accordance with an illustrative embodiment;

FIG. 7 depicts a flowchart of an example process for virtual machine migration compute resource management; and

FIG. 8 depicts a flowchart of an example process for virtual machine migration compute resource management.

### DETAILED DESCRIPTION

Virtual machine (VM) migration involves the movement of at least one VM from a source host computer environment, to a target host computer environment. The movement of the at least one VM from the source host computer environment to the target host computer environment includes allocating compute resources on the target environment based on the consumption of compute resources on the source host environment. It may be the case that a source computer environment is physically different from a target host environment. For example, the target host environment may include a different CPU, memory, data storage, and so forth compared to the source host environment. Thus, to accomplish a successful VM migration, it is important for an administrator of a VM migration to be aware of the compute resources currently utilized by the VM utilizing the source host environment, as well as the differences between the source host environment and the target host environment.

In many instances, a company may license compute resources of a physical host environment that is hosting one or VMs. The terms of the license between the company and the licensee may be based on a licensing agreement between the parties. The terms of the licensing agreement may include terms that dictate the amount of compute resources that a company pays for from the host company. Thus, when migrating VMs from one physical host to another physical host, it is necessary to understand the compute resources that are currently being consumed on the source physical host, as well as the compute resources that will be consumed on the target physical host post migration, as well as the total amount of compute resources that may be consumed during migration.

Currently there is no way to ensure that the amount of compute resources utilized by one or more VMs hosted on a source host will exceed a predefined upper limit of compute resources upon migrating the VMs to a new target host. As a result, current efforts in this regard are inefficient and ineffective due to the current inability to manage and/or adjust the total amount of compute resources consumed by a set of virtual machines according to a predefined limit, at least to prevent consumption of compute resources from exceeding the predefined limit.

The present disclosure addresses the deficiencies described above by providing a process (as well as a system, method, machine-readable medium, etc.) that develops a system that assesses the types and/or amounts of compute resources utilized by one or more VMs, sets a limit for the types and/or amounts of compute resources utilized by the one or more VMs, allocates compute resources on a target host based at least in part on the limit, migrates the one or more VMs from a source host to the target host with respect to the limit on compute resource utilization.

The illustrative embodiments provide for virtual machine migration resource management. A resource as referred to herein includes any compute resources including computer hardware components, including but not limited to, CPUs, computer memory, storage disks, etc. Examples embodiments disclosed herein refer to the compute resources in terms of CPU elements; however, use of this example is not intended to be limited, but is instead used for descriptive purposes only. Instead, resources may include any type and amount of compute resources used in connection with hosting a virtual machine on a physical computer environment.

As used throughout the present disclosure, the term “virtual machine” (or simply “VM”) refers to a self-contained software instance that emulates a complete computer system. including its own virtual CPU, memory, disk storage, and network interfaces. As used throughout the present disclosure, the term “VM migration” refers to the process of transferring one or more VMs from one particular physical computer environment, to another physical computer environment. VM migration may include both the transfer of compute resources, as well as storage.

As used throughout the present disclosure, the term “host computer” or simply “host” refers to a physical computing environment. As used throughout the present disclosure, the term “source host” refers to a host on which one or more virtual machines are currently being hosted at a present moment in time. As used throughout the present disclosure, the term “target host” refers to a host on which one or more virtual machines are intended to be migrated from the source host.

As used throughout the present disclosure, the term “hypervisor” refers to a type of computer software, firmware, and/or hardware that creates and runs a virtual machine. A hypervisor enables a host computer to support multiple guest VMs by virtually sharing the host computer's compute resources, such as processing related resources, memory, memory related resources, storage related resources, etc. Accordingly, a hypervisor manages the allocation of physical computer resources of a host computer to one or more virtual machines being hosted on the host computer.

As used throughout the present disclosure, the term “natural language processing” (or simply “NLP”) refers to a field of artificial intelligence (AI) concerned with enabling computers with the ability to understand text and/or spoken words in much the same way a human being might be able to understand written and/or spoken language. NLP involves an interdisciplinary study of computer science and linguistics, and includes enabling computers extract, manipulate and/or produce speech. Further, NLP involves processing natural language datasets, such as text corpora and/or speech corpora, using rule-based and/or probabilistic (i.e., statistical-based and neural network based) machine learning approaches. NLP includes the development of computer programs capable of “understanding” the contents of documents, including the contextual nuances of the language within the documents. NLP technology may accurately extract information and insights contained in the documents as well as categorize and organize the documents themselves. As a non-limiting example, an NLP program may be developed to extract relevant details from a contractual agreement, including terms related to licensing a product and/or service.

Illustrative embodiments include assessing compute resources utilized by one or more virtual machines. In an embodiment, assessing compute resources utilized by one or more virtual machines may be based in part on assessing the minimum resource requirements for the one or more virtual machines. In an embodiment, assessing compute resources utilized by one or more virtual machines may be based at least in part on assessing actual consumption of compute resources. In an embodiment, assessing compute resources utilized by one or more virtual machines may be based at least in part on compute resources allocated according to a compute resource licensing agreement. In some such embodiments, determining resources allocated according to a licensing agreement may include extracting licensing details from a contractual agreement using an NLP algorithm.

Illustrative embodiments include generating a compute resource allocation limit parameter. In an embodiment, the compute resource allocation limit parameter may be based at least in part on licensing agreement details, compute resource requirements, compute resource consumption, and/or compute resource availability. Illustrative embodiments further include allocating compute resources on a host computer based at least in part on the compute resource allocation limit parameter. Illustrative embodiments further include generating and providing a set of options for compute resource allocation based at least in part on a compute resource allocation limit parameter.

Illustrative embodiments include migrating least one virtual machine located on a first host system to a second host system, wherein prior to initiating the migration, an auxiliary add-on program of an application program that is associated with the automatic configuration, coordination and managing (orchestration) of data, queries: ingestion of license information associated with data related to a software license in respect to the first and second host system (e.g., cost, duration, etc.), and generation of correlation information associated with information that reflects a correlation of the license information with at least one infrastructure parameter of the respective first and second host systems. In some embodiments, the auxiliary program provides options for migrating the at least one virtual machine from the first host system to the second host system within pre-defined parameters associated with said license information based upon said correlation information and virtual machine parameters indicative of capacity/performance requirements of the first and second host system.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

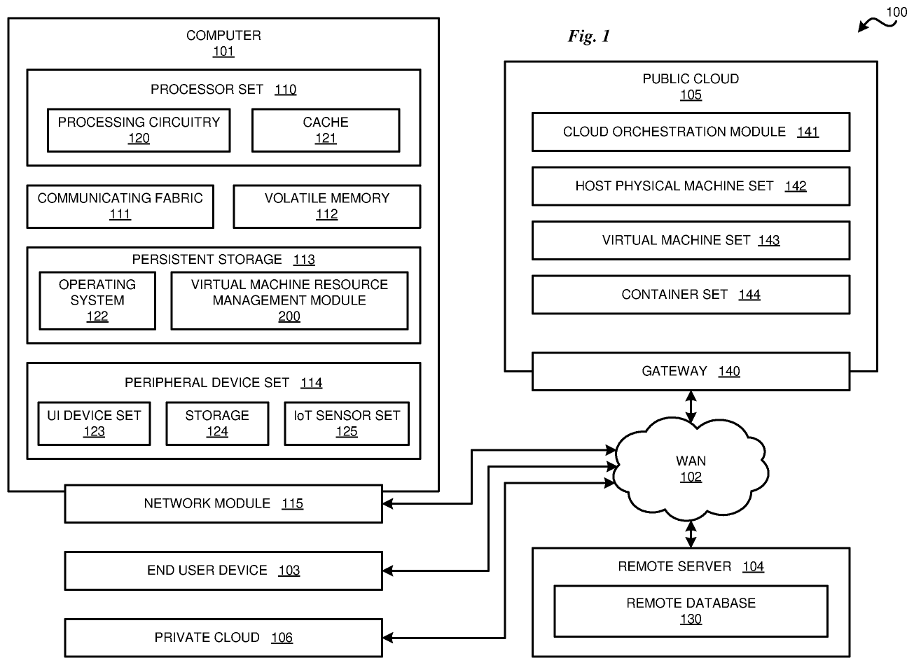

With reference to FIG. 1, this figure depicts a block diagram of a computing environment 100. Computing environment 100 contains an example of an environment for the execution of at least some of the computer code involved in performing the inventive methods, such as virtual machine resource management module 200 that assesses compute resource utilization corresponding to one or more virtual machines hosted on a current host computer system and migrates the one or more virtual machines to a new host while managing the amount of compute resources consumed by the one or more virtual machines during and after the migration from the current host to the new host. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container sct 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

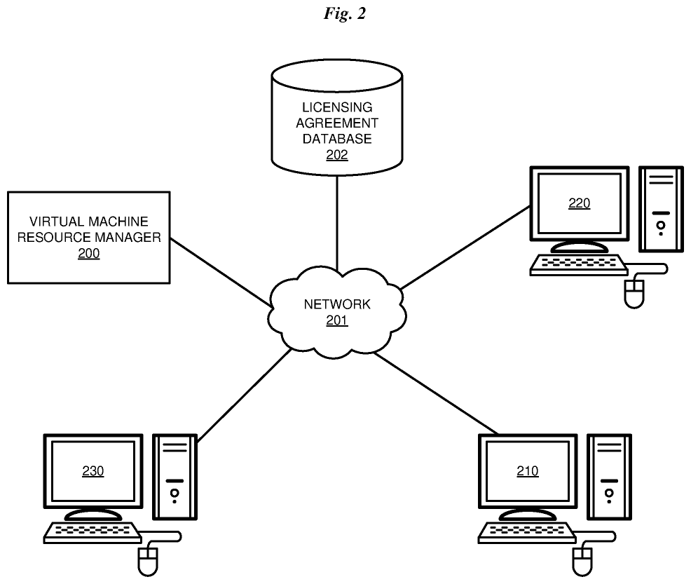

With reference to FIG. 2, this figure depicts a block diagram of an example computing environment in accordance with an illustrative embodiment. In the illustrated embodiment, the virtual machine resource management module 200 includes virtual machine resource management module 200 of FIG. 1.

In the illustrated embodiment, the virtual machine resource management module 200 is in communication with a first host computer environment 210 and a second host computer environment 220 via network 201. In an embodiment, network 201 includes any suitable network or combination of networks such as the Internet, etc. and may use any suitable communication protocols such as Wi-Fi, Bluetooth, etc., to enable virtual machine resource management module 200 to monitor, communicate with, and/or control certain aspects of the first host computer environment 210 and the second host computer environment 220. In an embodiment, first host computer environment 210 and second host computer environment 220 are each configured to host any number of virtual machines (VM). In some embodiments, virtual machine resource management module 200 is stored on a remote storage device (not shown). In some other embodiments, virtual machine resource management module 200 is stored on a non-transitory computer readable medium of administrator device 230. First host computing device 210, second host computing device 220, and administrator device 230 may include any suitable computing device, including but not limited to, server, a desktop computer, a laptop, a tablet, a smartphone, an embedded system, etc.

In the illustrated embodiment, virtual machine resource management module 200 is a software module configured to monitor, assess, manage, allocate, limit, and/or restrict computer resources that may be consumed one or more VMs hosted on first host computing device 210 and/or second host computing device 220. In an embodiment, virtual machine resource management module 200 is configured to provide a fully automatic and/or a semi-automatic method of performing a migration of multiple VMs from the first host computing device 210 to the second host computing device 220 without a risk of increasing compute resource utilization either during and/or after migration.

In the illustrated embodiment, licensing agreement database 202 stores licensing agreement data related to licensing compute resources for hosting VMs. In an embodiment, virtual machine resource management module 200 ingests licensing agreement data stored on licensing agreement database 202 and extracts relevant licensing agreement details corresponding to information regarding licensing a type and/or amount of compute resources. In the illustrated embodiment, administrative device 230 enables a person having suitable administrative privileges to modify one or more parameters and/or features associated with virtual machine resource management module 200.

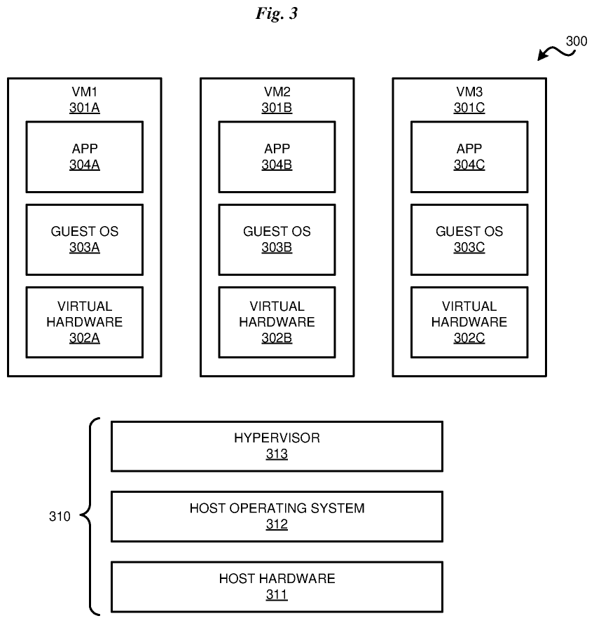

With reference to FIG. 3, this figure depicts a block diagram of an example virtual machine host environment in accordance with an illustrative embodiment. In the illustrated embodiment, the virtual machine (VM) host environment 300 is shown including a host computer system 310, the host computer hosting a first VM 301a, a second VM 301b, and a third VM 301c.

In the illustrated embodiment, the host computer system 310 is shown including host hardware 311, host operating system 312, and hypervisor 313. The host computer system 310 may include any type of computer, including but not limited to, a server, a desktop computer, a laptop, and embedded device, etc. The host hardware 311 includes any computer hardware, including but not limited to, one or more CPUs, GPUs, computer memory, storage devices, network interfaces, etc. The host operating system 312 includes any suitable operating system 312 that is running on the host computer system 310. The exact host operating system 312 may be implementation-specific and dependent upon the configuration and specification of the host computer system 310.

In the illustrated embodiment, the hypervisor 313 includes a software and/or hardware component that enables multiple VMs to run on the same host computer system 310. The hypervisor 313 sits between the physical host hardware 311 (CPU, GPU, memory, storage, network interface, etc.) and the virtual machines 301a, 301b, and 301c. Accordingly, the hypervisor 313 provides isolation between the virtual machines and enables each VM to operate as if the VM were running on its dedicated hardware, preventing one VM from interfering with or accessing the resources of another VM. In an embodiment, the hypervisor 313 includes a Type 1 Hypervisor (also known as a bare-metal hypervisor) that runs directly on the physical hardware without an underlying operating system. In an embodiment, the hypervisor includes a Type 2 Hypervisor (also known as a hosted hypervisor) that runs on top of an existing operating system.

The hypervisor 313 abstracts the underlying host hardware 311, presenting a virtualized view to the VMs 301a, 301b, and 301c. This abstraction enables multiple VMs to run concurrently on the same host computer system 310 without direct access to the host hardware 311. The hypervisor 313 manages the allocation of physical resources to virtual machines. Accordingly, the hypervisor 313 decides how much CPU, memory, storage, and network bandwidth each VM can use. In an embodiment, the resource allocation is dynamic and may be adjusted based on workload demands. In an embodiment, the hypervisor 313 includes one or more resource scheduling algorithms to efficiently utilize available resources, such as by managing CPU time-sharing among VMs, allocating memory as needed, and controlling network and/or storage access. Further, the hypervisor 313 manages I/O operations from VMs to physical devices. In an embodiment, the hypervisor 313 may include the utilization of techniques such as paravirtualization or device pass-through to optimize I/O performance.

In an embodiment, the hypervisor 313 enables an authorized user or administrator to create and manage virtual machines, and may include tools for creating VMs, specifying their hardware requirements, and installing guest operating systems. In an embodiment, the hypervisor 313 includes a management interfaces and tools that allow an authorized user or administrator to monitor the health and performance of VMs. Further, the management interfaces and/or tools may enable functions that include, but are not limited to, starting, stopping, pausing, and migrating VMs between physical hosts. In an embodiment, the hypervisors 313 support live migration, allowing VMs to be moved from one physical server to another while running.

In the illustrated embodiment, a first VM 301a, a second VM 301b, and a third VM 301c are shown. The first VM 301a includes a virtual hardware 302a, guest OS 303a, and a software application 304a. The second VM 301b includes a virtual hardware 302b, guest OS 303b, and a software application 304b. The third VM 301c includes a virtual hardware 302c, guest OS 303c, and a software application 304c. Although the virtual machine VM host environment 300 is shown including three VMs, it is contemplated herein that the VM host environment 300 may include any number of virtual machines hosted on a host computing system 310. In the illustrated embodiment, each set of virtual hardware of virtual hardware 302a, 302b, and 303c is abstracted by the hypervisor 313 to effectively isolate each virtual machine from each other on host computing system 310. As described herein, each virtual hardware may include an allocated amount of compute resources, including but not limited to, CPU, memory, storage, network bandwidth, etc.

In the illustrated embodiment, the guest operating system (OS) of each virtual machine includes an operating system that is installed and runs within the virtual machine. Accordingly, each guest OS interacts with the virtualized hardware provided by the hypervisor as if it were running on a physical machine. In the illustrated embodiment, each virtual machine 301a, 301b, and 301a includes a separate guest OS 303a, 303b, 303c, respectively, and in some embodiments, each of the guest OS instances may be different from one another. Each guest OS is responsible for executing one or more applications (such as software application 304a, 304b, and 304c) and managing resources within each respective virtual machine. Further, each guest OS interacts with the virtual hardware 302a, 302b, and 302c respectively, provided by the hypervisor 313, while isolated and unaware of the physical host hardware 311 of the host computing system 310.

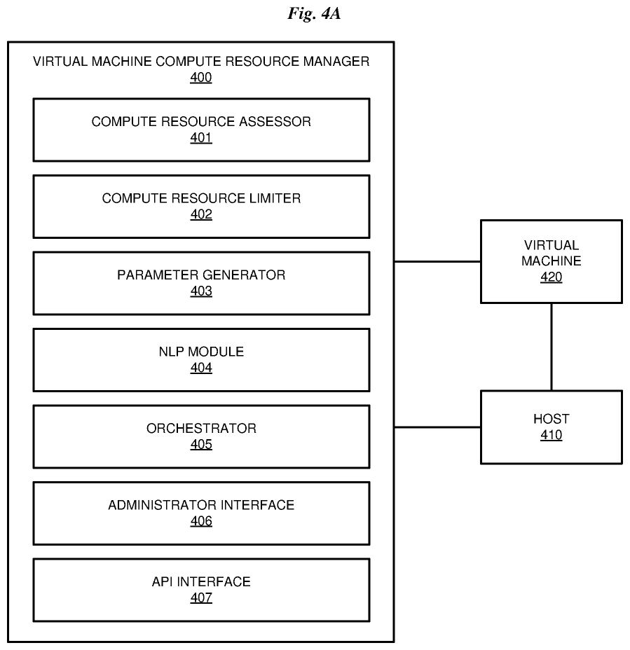

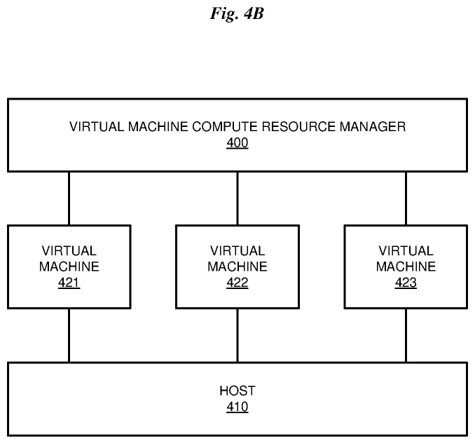

With reference to FIG. 4A, this figure depicts a block diagram of an example virtual machine compute resource management module. In the illustrated embodiment, the virtual machine compute resource management module 400 includes the virtual machine compute resource management module 200 of FIG. 1.

In the illustrated embodiment, the virtual machine compute resource manager module 400 includes a compute resource assessor 401, compute resource limiter 402, parameter generator module 403, natural language processing (NLP) module 404, orchestrator module 405, administrative interface module 406, and API interface module 407. In some embodiments, the virtual machine compute resource manager module 400 is part of a hypervisor layer (such as hypervisor 313 of FIG. 3) and may be configured to interact with and possess at least all of the same functionalities as a hypervisor. In some embodiments, the virtual machine compute resource manager module 400 is an auxiliary add-on program that communicates and interacts with a virtual machine, hypervisor, and/or VM migration software. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the compute resource assessor 401 is a software module configured to assess the type and amount of compute resource allocated to and/or consumed by a virtual machine, such as virtual machine 420 running on host 410. In an embodiment, virtual machine 420 may include any virtual machine 301a, 301b, 301c of FIG. 3, and host 410 may include host computer system 310 of FIG. 3.

In the illustrated embodiment, the compute resource limiter module 402 is a software module configured to limit the type and/or amount of compute resources allocated for hosting a virtual machine. In an embodiment, the resource limiter module 402 limits the type and/or amount of compute resources allocated on a physical host according to a compute resource allocation limit parameter. In the illustrative embodiment, the parameter generator module 403 is a software module configured to generate a compute resource allocation limit parameter. In an embodiment, the parameter generator module 403 generates a compute resource allocation limit parameter based at least in part on a licensing agreement defining licensing compute resources for one or more virtual machines. In the illustrated embodiment, the NLP module 404 is a software module that includes at least one NLP algorithm configured to detect and extract terms related to compute resource allocation within a licensing agreement.

In the illustrated embodiment, orchestrator module 405 is a software module that is configured to coordinate and manage data and instructions to automatically migrate a virtual machine from a source host to a target host. In an embodiment, the orchestrator module 405 queries ingestion of license information associated with data related to a software license in respect to the source and target host system (e.g., cost, duration, etc.), as well as queries the generation of correlation information associated with information that reflects a correlation of the license information with at least one infrastructure parameter of the respective source and target host systems. In some embodiments, the orchestrator module 405 provides a set of options for migrating the at least one virtual machine from the source host system to the target host system within pre-defined parameters associated with said license information based upon said correlation information and virtual machine parameters indicative of capacity/performance requirements of the source and target host system.

In the illustrated embodiment, the administrative interface module 406 is a software module configured to enable a user having sufficient privileges to adjust one or more parameters utilized by virtual machine resource management module 400, such as the compute resource allocation limit parameter. In the illustrated embodiment, API interface module 407 is a software module that enables virtual machine resource management module 400 to interact with software related to a virtual machine and/or host environment, such as a hypervisor, operating system, and any other computer program(s) that may be utilized for the execution of processes performed by the virtual machine resource management module 400, such processes including but not limited to, allocating compute resources for a set of virtual machines and migrating the set of virtual machines from a source host to a target host in observance of a predefined compute resource allocation limit.

With reference to FIG. 4B, this figure depicts a block diagram of an example virtual machine compute resource management infrastructure in accordance with an illustrative embodiment. In an embodiment, first virtual machine 421 includes first virtual machine 301a, second virtual machine 422 includes second virtual machine 301b, and third virtual machine 423 includes third virtual machine 301c of FIG. 3. In the illustrated embodiment, host 410 may include host computer system 310 of FIG. 3.

In the illustrated embodiment, the virtual machine resource manager module 400 is shown managing resources of the first virtual machine 421, second virtual machine 422, and third virtual machine 423. In a scenario where a migration is initiated from the current physical host 410 to a new host (not shown), virtual machine compute resource manager module 400 ensures that a predetermined type and/or amount of total compute resources allocated and/or consumed is not exceed during the migration process.

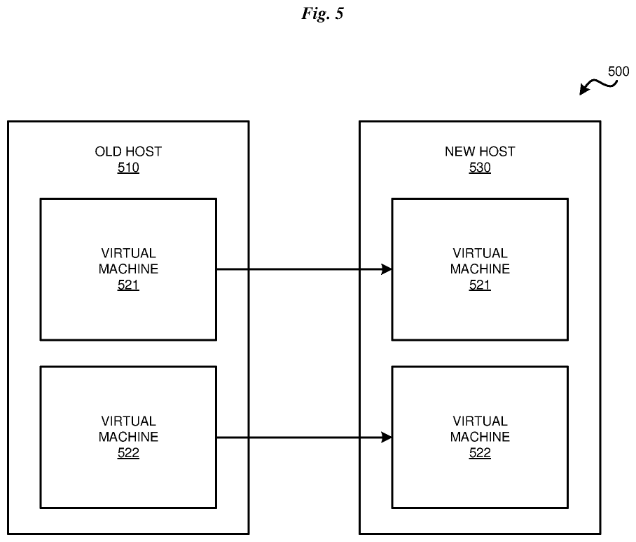

With reference to FIG. 5, this figure depicts a block diagram an example virtual machine (VM) migration process in accordance with an illustrative embodiment. In the illustrated embodiment, the VM migration process 500 includes migrating a first virtual machine 521 and a second virtual machine 522 from an old host 510 to a new host 530. The process 500 of migrating a first virtual machine 521 and a second virtual machine 522 may generally include the following steps. The process 500 includes assessing the compute resource requirements for the first virtual machine 521 and the second virtual machine 522. Examples of compute resource requirements may include, but are not limited to, CPU requirements, memory requirements, storage requirements, network bandwidth requirements (e.g., network throughput), GPU requirements, specialized hardware requirements, workload and/or application dependencies, redundancy requirements, and/or scaling requirements. Examples of CPU requirements may include, but are not limited to, number of CPU cores, CPU speed, and/or CPU instruction sets. Examples of memory requirements may include, but are not limited to, type of memory (e.g., RAM, SDRAM, DDR5, etc.), amount of memory, and/or memory speed. Examples of storage requirements may include, but are not limited to, disk space, storage type (e.g., HDD, SSD, NVMe, etc.), and/or I/O operations per second (IOPS).

Further, depending on the task(s) performed by the virtual machine, the virtual machine may also require GPU resources in addition to CPU and RAM resources. Examples of GPU requirements may include, but are not limited to, GPU type, GPU chipset, GPU memory, GPU clock, etc. Further, depending on the on the task(s) performed by the virtual machine, the virtual machine may also require specialized hardware. Examples of specialized hardware requirements may include, but are not limited to, trusted platform module (TPM), hardware security module (HSM), field programmable gate array (FPGA), etc. Further, if high availability is a consideration, additional redundant compute resources may be allocated to ensure failover capability. Further, additional compute resources may be allocated to enable dynamic scaling and/or auto-scaling based on demand.

Further, the process 500 may include allocating resources on the new host 530. It is contemplated herein that the compute resource available on the new host 530 may differ from the compute resources utilized from the old host 510. In such a scenario, the process 500 may include ensuring that the compute resources of the new host 530 are compatible with the requirements of the first virtual machine 521 and the second virtual machine 522, and/or handling any discrepancies arising out of migrating from the old host 510 to the new host 530. Further, the process 500 may include ensuring that the old host 510 and the new host 530 are on the same network and/or have proper network connectivity for data network.

Further, the process 500 may include suspending/pausing VM on the old host 510, while maintaining the VM's memory and disk state. Further, the process 500 may include transferring the VM's memory and state (RAM contents, CPU registers, etc.) from the old host 510 to the new host 530 over a network. Further, the process 500 may include continuously copying incremental changes in memory and state to minimize downtime. Further, once a sufficient amount of the VM's state is on the target host, the process 500 may switch the VM's execution from the old host 510 to the new host 530, and resume the VM on the new host 530. Further, once migration has been accomplished, the process 500 may release the compute resources on the old host 510. Embodiments of the process 500 may further include performing a storage migration, which may include copying the VM's disk files to the new host 530 storage while keeping the VM running on the old host 510. After the storage copy is complete, the process 500 may update the VM configuration to point to the new storage location. If live migration is not feasible or preferred, the process 500 may include shutting down each virtual machine on the old host 510, transferring the VM files (disks and configuration) to the new host 530, and then running the VM on the new host 530.

It is contemplated herein that in a scenario such as the scenario depicted by FIG. 5, there may be a moment in time during process 500 when two or more VMs may reside on different hosts, which may potentially cause an increase in resource utilization (as well as an increase in charge of licensing fee for resource utilization). Embodiments include a fully automatic method of performing a migration of multiple VMs to a new host or hosts without a risk of increasing compute resource utilization. Further, embodiments provide options for migrating the at least one virtual machine from the old host 510 to the new host 530 within pre-defined parameters. In an embodiment, the pre-defined parameters include a set of parameters associated with license information based upon correlation information and virtual machine parameters indicative of capacity/performance requirements of the old host 510 and new host 530.

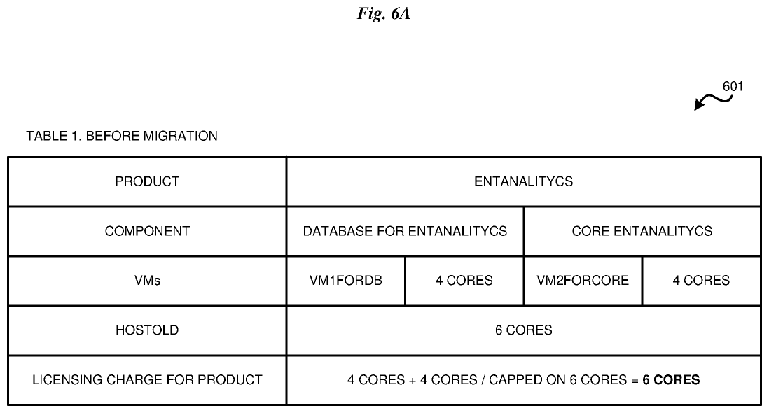

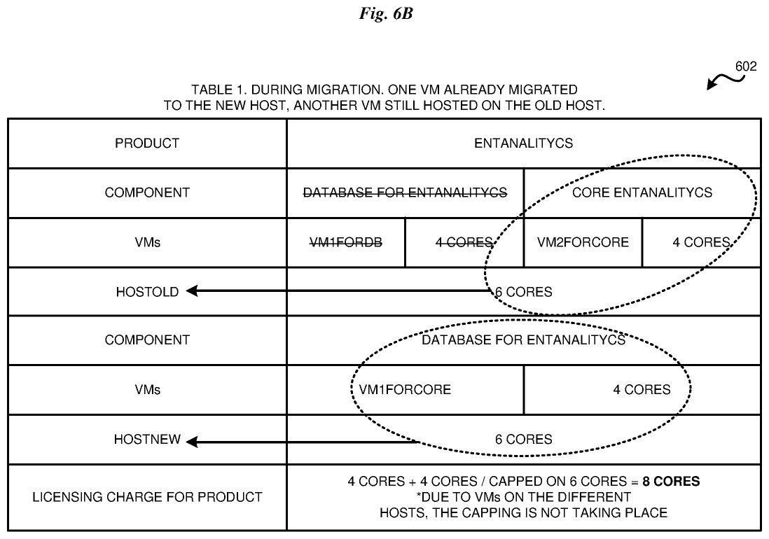

With reference to FIG. 6A, this figure depicts an example table illustrating a hypothetical pre-migration scenario in accordance with an illustrative embodiment. The example scenario depicted by FIG. 6A (as well as FIG. 6B) includes two VMs sharing two components of a single software product running on one host that need to be migrated to a new host. Accordingly, two (or more) virtual machines may share computer resources and run the same software product (that may comprise multiple software components) that might be capped on the host level. For example, it might be the database and the processing component, as shown in FIG. 6A and FIG. 6B. As shown by table 601, the software product “EntAnalytics” utilizes 2 virtual machines, with each virtual machine capable of consuming up to 4 cores each. However, while hosted on the old host, the hypervisor of the old hosts allocates a total of 6 cores across both virtual machines, thereby capping the total number of cores consumed to 6 cores. In the illustrative embodiment, terms of a licensing agreement cover 6 cores for a particular price, so by capping the total number of cores consumed by the virtual machines, the terms of the licensing agreement are not exceeded.

With reference to FIG. 6B, this figure depicts a table illustrating a hypothetical migration scenario in accordance with an illustrative embodiment. As shown by table 602, one of two virtual machines has already been migrated to a new host, while the other virtual machine still exists on the old host. Accordingly, when such a virtual environment is being migrated to another host, there may be a moment in time when two or more VMs may reside on different hosts, which may potentially cause an increase in resource utilization and a resultant increase licensing charge. For example, suppose a high-water mark service model, under which compute resource charges are counted according to the highest usage during a reported period. The depicted migration as shown may ordinarily result in increasing from 6 to 8 cores usage for the reported period, thereby causing an increase in compute resource usage charge under the licensing agreement. To prevent the occurrence of such a scenario, embodiments disclosed herein include developing and providing an add-on orchestrator that queries a licensing service details, hypervisors, and scripts/instructions to execute a migration from a first host to a second host without incurring additional licensing costs by ensuring that a resource allocation limit is not exceed across any combination of the host environments.

For example, in order to keep within the limits of the licensing agreement, the compute resource allocation of VM2 may be reduced to prevent exceeding the capacity limit defined by the licensing agreement. To continue on the non-limiting example, suppose that the capacity limit is 6 cores according to the licensing agreement. In such a scenario, the compute resource allocation of VM2 may be reduced to 2 cores, so that the capacity limit of 6 cores under the licensing agreement is not exceeded. Although the example of a capacity limit defined by a licensing agreement is provided as an example, the use of this example is non-limiting, and the capacity limit may be defined according to the desire of the user and/or administrator of the migration. For example, it may be the case that the administrator may want to reduce the amount of compute resources consumed on the new host, in which case, the administrator may define a limit that is less than the original capacity.

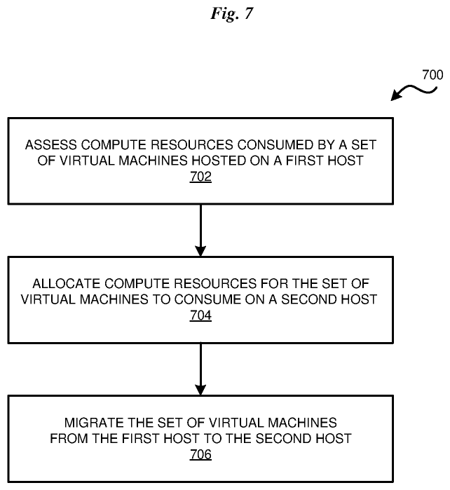

With reference to FIG. 7, this figure depicts a flowchart of an example process for virtual machine migration compute resource management. In an embodiment, virtual machine compute resource management module 200 of FIG. 1 and/or virtual machine compute resource management module 400 of FIG. 4A and FIG. 4B carries out the steps of process 700.

At step 702, the process assesses the computer resources consumed by a set of virtual machines hosted on a first (source) host. A set of virtual machines may include any number of virtual machines, including one or more virtual machines. The compute resources may include any compute resources, including but not limited to, CPU utilization, memory utilization, disk storage, network bandwidth, etc. In an embodiment, assessing the computer resources may include assessing the type and/or the amount of computer resources consumed. As a nonlimiting example, the type of resource may include a specific type of processor, while the amount may include a specific utilization rate of a number of cores of the processor.

In an embodiment, the compute resources consumed may be based at least in part on compute resources allocated based on a compute resource licensing agreement. For example, a compute resource licensing agreement may include specific terms that indicate the type and/or amount of compute resources that may be consumed by the set of virtual machines hosted on the first host. In an embodiment, the assessing the compute resource consumed according to a compute resource licensing agreement may be accomplished via one or more natural language processing (NLP) algorithms configured to detect and extract terms related to compute resource allocation within a licensing agreement.

At step 704, the process allocates compute resources that may be consumed by the set of virtual machines on a second (target) host. Accordingly, when the set of virtual machines is migrated from the first host to the second host, the type and amount of compute resources consumed may be different on the second host compared to the first host. For example, it may be the case that the second host includes different types of processors than the first host, and/or that the second host utilize more CPU cores compared to the first host, in which case the amount and type of compute resources would be different on the second host compared to the first host. In an embodiment, allocating compute resources that may be consumed by the set of virtual machines on the second host may be based at least in part on a compute resource licensing agreement, and accordingly may be determined via one or more NLP algorithms configured to detect and extract terms related to compute resource allocation within a licensing agreement.

At step 706, the process migrates the set of virtual machines from the first host to the second host. In an embodiment, migrating the set of virtual machines form the first host to the second host includes restricting the compute resources consumed by the set of virtual machines on the second host based at least in part on the compute resources allocated during step 704. Accordingly, restricting the compute resources consumed mitigates the risk of increasing compute resource utilization that may otherwise occur as a result of migrating the set of virtual machines from the first host to the second host. In an embodiment, restricting the compute resources is accomplished by proportionally reducing the amount of compute resources allocated to each virtual machine during migration, reducing the amount of compute resources allocated to each virtual machine to minimum operating requirements, and/or manually selecting an amount by which to reduce the amount of compute resources allocated.

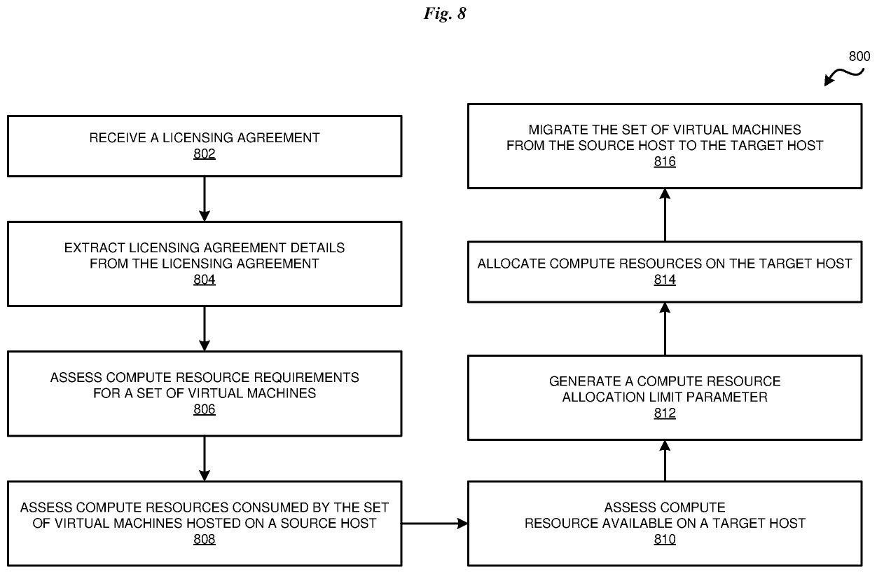

With reference to FIG. 8, this figure depicts a flowchart of an example process for virtual machine migration compute resource management. In an embodiment, virtual machine compute resource management module 200 of FIG. 1 and/or virtual machine compute resource management module 400 of FIG. 4A and FIG. 4B carries out the steps of process 800.

At step 802, the process receives a licensing agreement. The licensing agreement may define the type and/or amount of compute resources that may be utilized by a set of virtual machines. At step 804, the process extracts licensing agreement details from the licensing agreement. In an embodiment, the licensing agreement details include a set of terms that define the type and/or amount of compute resources that may be utilized by a set of virtual machines. Accordingly, the process ingests licensing data corresponding to consumption of compute resources of a physical computer host environment. The licensing data may include information such as products with licensing values, i.e., cores, relations between products and components, etc.

At step 806, the process assesses the compute resource requirements for a set of virtual machines. Accordingly, there may be different compute resource requirements depending on the purpose, application, configuration, desired performance, etc. of the set of virtual machines. In an embodiment, assessing the compute resource requirements includes determining the minimum type and/or amount of compute resources necessary to successfully run one or more virtual machines. In an embodiment, assessing the compute resource requirements may include determining the minimum compute resource requirements for each virtual machine of the set of virtual machines. For example, it may be the case that a first virtual machine requires only 1 core, while a second virtual machine requires 2 cores, and a third virtual machine requires 4 cores. In such a scenario, allocation of compute resources may be prevented from being reduced below 1 core for the first virtual machine, below 2 cores for the second virtual machine, and below 4 cores for the third virtual machine.

At step 808, the process assesses the compute resources consumed by the set of virtual machines on a source host. In an embodiment, the process assesses the compute resources consumed by each virtual machine of the set of virtual machines. In an embodiment, the actual compute resources consumed by each virtual machine of the set of virtual machines may be a consideration for allocation of compute resources on the new host for the set of virtual machines. At step 810, the process assesses the compute resources available on a target host. In an embodiment, the compute resources available on the target host may be a consideration for allocation of compute resources on the target host for the set of virtual machines.

At step 812, the process generates a compute resource allocation limit parameter. In an embodiment, the compute resource allocation limit parameter may be based at least in part on licensing agreement details, compute resource requirements, compute resource consumption, and/or compute resource availability. The compute resource allocation limit parameter defines a maximum limit on the type and/or amount of compute resources that may be consumed by set of virtual machines across any combination of the source host and the target host. Accordingly, during a migration from a source host to a target host, it may be the case that the set of virtual machines is distributed between the source host and the target host, which may result in exceeding the previous amount of compute resources consumed on the source host alone. The compute resource allocation limit parameter may ensure that the compute resources that may be consumed by set of virtual machines across any combination of the source host and the target host does not exceed a predefined limit.

At step 814, the process allocates compute resources on the target host. In an embodiment, the process allocates compute resources on the target host based on the compute resource allocation limit parameter. In some embodiments, allocating compute resources may include allocating the minimum required compute resources for each virtual machine of the set of virtual machines. In some embodiments, allocating compute resources may include reducing the allocated compute resources for each virtual machine by half. In some other embodiments, allocating compute resources may include manually adjusting compute resources allocated for a subset of the set of virtual machines. In some embodiments, allocating compute resources may be accomplished via any combination of proportional reduction, reducing to minimum requirements, and/or manual reduction of at least a portion (or all) of the set of virtual machines. The specific manner in which compute resources on the target host may be allocated may be implementation specific. In some embodiments, the process further includes providing a set of options for allocating compute resources on the target host for each virtual machine of the set of virtual machines. For example, the set of options may include different configurations of allocating resources for each virtual machine and/or for a subset of virtual machines, within predetermined resource allocation limits. At step 816, the process migrates the set of virtual machines from the source host to the target host.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating a compute resource allocation limit parameter for controlling a total amount of compute resources consumed by a set of virtual machines over a combination of a source host environment and a target host environment;
adjusting an allocation of compute resources for the set of virtual machines according to the compute resource allocation limit parameter; and
migrating the set of virtual machines from the source host environment to the target host environment.

2. The computer-implemented method of claim 1, wherein generating the compute resource allocation limit parameter is based at least in part on a set of service license agreement details corresponding to a licensed amount of compute resources.

3. The computer-implemented method of claim 2, further comprising parsing a service license agreement to extract the set of service license agreement details from the service license agreement via an NLP algorithm.

4. The computer-implemented method of claim 1, further comprising generating a set of options for adjusting the allocation of compute resources for the set of virtual machines.

5. The computer-implemented method of claim 1, wherein generating the compute resource allocation limit parameter is based at least in part on manually defining a limit for compute resource consumption for a subset of the set of virtual machines.

6. The computer-implemented method of claim 1, wherein generating the compute resource allocation limit parameter is based at least in part on minimum requirements for each virtual machine of the set of virtual machines.

7. The computer-implemented method of claim 1, wherein generating the compute resource allocation limit parameter is based at least in part on a proportional reduction of allocation of compute resources for each virtual machine of the set of virtual machines.

8. A computer program product for managing compute resource allocation for a set of virtual machines comprising one or more computer readable storage media, and program instructions collectively stored on the one or more computer readable storage media, the program instructions executable by a processor to cause the processor to perform operations comprising:
generating a compute resource allocation limit parameter for controlling a total amount of compute resources consumed by the set of virtual machines over a combination of a source host environment and a target host environment;
adjusting an allocation of compute resources for the set of virtual machines according to the compute resource allocation limit parameter; and
migrating the set of virtual machines from the source host environment to the target host environment.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein generating the compute resource allocation limit parameter is based at least in part on a set of service license agreement details corresponding to licensed amount of compute resources.

12. The computer program product of claim 11, further comprising parsing a service license agreement to extract the set of service license agreement details from the service license agreement via an NLP algorithm.

13. The computer program product of claim 8, further comprising generating a set of options for adjusting the allocation of compute resources for the set of virtual machines.

14. The computer program product of claim 8, wherein generating the compute resource allocation limit parameter is based at least in part on manually defining a limit for compute resource consumption for a subset of the set of virtual machines.

15. The computer program product of claim 8, wherein generating the compute resource allocation limit parameter is based at least in part on minimum requirements for each virtual machine of the set of virtual machines.

16. The computer program product of claim 8, wherein generating the compute resource allocation limit parameter is based at least in part on a proportional reduction of allocation of compute resources for each virtual machine of the set of virtual machines.

17. A computer system comprising a processor and one or more computer readable storage media, and program instructions collectively stored on the one or more computer readable storage media, the program instructions executable by the processor to cause the processor to perform operations comprising:
generating a compute resource allocation limit parameter for controlling a total amount of compute resources consumed by a set of virtual machines over a combination of a source host environment and a target host environment;
adjusting an allocation of compute resources for the set of virtual machines according to the compute resource allocation limit parameter; and
migrating the set of virtual machines from the source host environment to the target host environment.

18. The computer system of claim 17, wherein generating the compute resource allocation limit parameter is based at least in part on a set of service license agreement details corresponding to a licensed amount of compute resources.

19. The computer system of claim 18, further comprising parsing a service license agreement to extract the set of service license agreement details from the service license agreement via an NLP algorithm.

20. The computer system of claim 19, further comprising generating a set of options for adjusting the allocation of compute resources for the set of virtual machines.
